(19) United States
(12) Patent Application Publication
(10) Pub. No.: US 2018/0313112 A1
(43) Pub. Date: Nov. 1, 2018

(54) STRIKER FOR A WINDOW OR DOOR

(71) Applicant: Emmanuel VAN PARYS, Wortegem-Petegem (BE)

(72) Inventor: Emmanuel VAN PARYS, Wortegem-Petegem (BE)

(21) Appl. No.: 15/955,218

(22) Filed: Apr. 17, 2018

(30) Foreign Application Priority Data
Apr. 27, 2017 (BE) 2017/5298

(51) Int. Cl. E05B 15/02

(52) U.S. Cl. CPC E05B 15/024

(57) ABSTRACT

Disclosed is a striker for a window or door with a locking system with a striker and locking cam to lock it, which striker is intended to be able to make contact with a contact zone by way of the locking cam. The striker is composed of a foot and a head, whereby the foot in a mounted condition of the striker fits in several different positions between the flanks of the fitting groove, whereby the different positions differ from each other by a rotation of the striker around a geometric axis through a centre point of the foot, and whereby the head possesses at least two different the contact zones the distance of which is different to the geometric axis through the centre point of the foot and/or the thickness is different.

### BACKGROUND OF THE INVENTION

### Field of the Invention

The present invention relates to a striker for a window or door.

### Description of the Related Art

As is known, a window or door contains a fixed frame that is built into a wall opening with a wing that can be turned or tilted to open and close the window or the door.

The fixed frame and the wing are as is known composed of profiles, made of aluminium or the like which on the circumferential walls facing each other are provided with a fitting groove to mount all kinds of fittings.

Traditionally the window or the door are provided with a closing mechanism that is operated, for example, by a rotatable handle on the wing which sets a locking system or closing mechanism in motion that is built into and hidden in the space between the fixed frame and the wing.

This closing mechanism uses close slats which have been slidably mounted in an aforementioned fitting groove of the wing and which bear one or more locking cams which due to the movement of the handle can be hooked behind or in a striker that is mounted on the frame in a fixed way on the level of an aforementioned fitting groove along the inside circumference of the fixed frame.

Thus, the window or the door can be locked in a closed position. A reverse movement pulls out the locking cam from the striker to be able to turn open or tilt the window or the door.

Manufacturing and mounting tolerances cause deviations on the mutual positions between the wing and the frame in relation to the design situation, such that an adjustment of the closing mechanism is necessary, particularly an adjustment of the mutual position between the locking cam and the striker by adjusting the position of the striker on the wing, this to guarantee a play-free locking of the window or of the door.

In closed condition of the window or of the door there may be a deviation of the mutual distance between the circumferential walls facing each other of the fixed frame and of the wing in a direction parallel with the plane of the wing.

In that case the depth position of the striker perpendicular to the circumferential wall on which the striker is mounted in a fitting groove needs to be adjusted.

Another deviation that may occur is a deviating position of the walls of the frame facing each other and of the wing in a direction perpendicular to the plane of the wing.

That requires a lateral adjustment of the position of the striker in a direction perpendicular to the direction of the fitting groove and parallel with the circumferential wall on which the striker is mounted in a fitting groove.

An adjustment of the position of the striker along the fitting groove is also desirable.

In the known closing mechanisms, adjusting the position of the striker is relatively complex, time-consuming and requires several different components for the adjustment.

### SUMMARY OF THE INVENTION

The purpose of the present invention is to offer a solution for one or more of the aforementioned and other disadvantages.

To this end, the invention relates to a striker for a window or door with at least one profile with a fitting groove which breadthways is limited by two parallel flanks and is provided with a locking system with a striker and a co-operating locking cam to be able to lock the window or the door in closed condition, which striker is intended to be mounted on the level of said fitting groove and on locking to be able to make contact with a contact zone by means of the locking cam, whereby the striker is composed of a foot and a head mounted sideways thereon, whereby the foot in mounted condition of the striker fits in several different positions between the flanks of the fitting groove and whereby every position corresponds with a geometric centre line of the foot (13) which coincides with the middle line between the flanks (6) of the groove and the different positions differ from each other by a rotation of the striker around a geometric axis through a centre point that is located on said centre line or in the intersection of several centre lines of the foot and whereby the head possesses at least two different said contact zones of which the radial distance to said geometric axis through the centre point of the foot is different and/or the thickness is different.

An advantage of a striker according to the invention is that for every position of the foot in the fitting groove, each time another contact zone of the head opposite the locking cam is positioned.

By varying the radial distance of these contact zones to the geometric axis along the circumference, a simple lateral adjustment of the locking system is possible by simply mounting the striker in a different rotated position in the fitting groove such that the edge in a lateral direction in relation to the fitting groove can be moved further or closer to the middle of the fitting groove.

Analogously, by varying the thickness of the contact zones, more specifically the height in relation to the foot, a simple depth adjustment of the locking system of the window or door can be obtained by rotating the mounted position of the striker in relation to the fitting groove.

A combination of a variation of the radial distance and of the thickness of the contact zones of the head means that with one single striker both a lateral adjustment and a depth adjustment are possible.

Because the foot fits between the flanks of the fitting groove in every position, it is possible in every said position to also adjust the position of the striker along the length of the fitting groove by simply sliding the foot of the striker lengthways along the fitting groove.

Preferably, for each pair of said positions of the foot in which the foot fits between the flanks of the groove and which differ from each other by a rotation of the striker over a half turn around the geometric axis, two contact zones are provided which in relation to this geometric axis are located diametrically across from each other and at a different radial distance from it and/or with a different thickness.

Preferably the foot is executed as a disk with edges along its circumference in the form of a regular polygon with an even number of sides and characterised by an inscribed circle with a centre point that coincides with said centre point of the foot and a diameter that is equal to or slightly smaller than the width of the fitting groove.

In this embodiment the foot possesses an even number of straight edges, the facing edges of which are parallel to each other and at a normal distance from each other that is equal to or slightly smaller than the width of the fitting groove.

In this case you obtain a discrete number of different positions in which the foot fits in the fitting groove, whereby this number is equal to the number of sides of the regular polygon of the circumference of the foot. This number of possible positions is also the maximum number of settings for which the striker can be used.

This provides the advantage that such striker, or at least its foot, is easy to dimension and manufacture as a function of the width of the fitting groove for which the striker is intended and as a function of the desired number of settings.

10

An advantage of the straight opposite edges of the foot is that the striker in a mounted condition, more specifically with the foot between the flanks of the fitting groove, cannot be rotated inadvertently without the striker first having to be disassembled again and therefore the striker cannot be inadvertently disrupted.

In the extreme, the regular polygon has an infinite number of edges, which means the polygon is a circle with a diameter equal to or slightly smaller than the width of the fitting groove. In this case the striker can be mounted in an infinite number of settings by rotating, whereby in this case the adjustment by rotating is even possible in a mounted condition.

Relating to the lateral adjustment it is preferable that the circumference of the head is formed by a regular polygon, or in the extreme a circle, with an equal number of sides as the foot and with an inscribed circle the centre point of which is located excentrically in relation to said centre point of the foot and the contact zones are situated along the circumference of the head, preferably near the contact points of the edges with the inscribed circle.

The head of such striker is simple to dimension and manufacture just as the foot of the striker is.

Preferably the edges along the circumference of the head run parallel with the edges along the circumference of the foot, such that the adjustment becomes easier as in every position of the foot there are two edges which run parallel with the longitudinal direction of the fitting groove, and one edge of which lies further away from the middle of the fitting groove than the other edge and/or has another thickness.

According to a practical embodiment the diameter of the inscribed circle of the circumference of the head is greater than the diameter of the inscribed circle of the foot and thus also greater than the width of the fitting groove for which the striker is intended.

A striker as described above is preferably provided with a channel for a screw as well as a screw that fits in this channel with which the striker can be screwed in one of said positions by screwing the screw in the bottom of the fitting groove to fix the head of the striker against the flanks of the fitting groove.

This makes fixing the striker very simple.

According to an alternative embodiment in terms of the mounting of the striker on the profile, the foot of the striker, as described above, is provided with a clamping piece on the opposite side of the head which along every edge of the foot extends laterally with a collar in relation to the foot.

The striker can then be hooked behind the flanks of the fitting groove with said collar and be pushed away from the bottom of the fitting groove by means of a screw to clamp the striker with this collar against the back of the flanks so it is fixed.

An advantage of this attachment method is that the profile on which the striker is attached is not damaged by a screw and that a small correction of the position of the striker is possible by sliding it lengthways along the fitting groove without an already made screw hole being a problem for screwing tight the striker again when the new screw hole overlaps with the old screw hole.

To be able to hook and tilt such striker with a collar in the fitting groove, the head is preferably connected with the foot by means of a connecting piece with a thickness which is preferably greater than the thickness of the flanks of the fitting groove and which at least along two non-facing edges of the foot indents laterally in relation to these edges.

In this way sufficient freedom of movement is created to be able to tilt the striker in an aforementioned position in the fitting groove after the profiles of the window or door have already been assembled and therefore in other words at that time it is no longer possible to slide the striker along an open end of the fitting groove in the fitting groove.

According to a variant form of locking system the striker can be executed as a U-shaped profile which when locking the window or the door is slid over the locking cam, whereby the locking cam is, for example, executed as a pen that fits between the legs of the striker.

In that case the contact zones are located on the edges facing each other of the legs of the striker, whereby the head is oriented such that these edges run parallel with a centre line of the foot and are each located at a different distance from this centre line, whereby for use the striker must be turned such that the centre line in question of the foot runs parallel lengthways along the fitting groove and because of this the legs are also oriented according to this direction.

This provides the advantage that such locking system is easy to realise.

Preferably the foot is executed in such a way that it only permits two positions of the striker, whereby in every position the legs are oriented lengthways along the fitting groove.

Thus, the striker can never be positioned wrongly.

However, the adjustment by rotating such striker according to this variation is limited to two positions.

A broader adjustment can be made possible in that case by letting the thickness of the legs of the U-shaped profile vary in the profile direction of the legs.

An additional adjustment is then made possible by sliding the striker lengthways along the fitting groove.

### BRIEF DESCRIPTION OF THE DRAWINGS

With the intention of better showing the characteristics of the invention, a few preferred embodiments of a striker for a window or door according to the invention are described hereinafter by way of an example, without any limiting nature, with reference to the accompanying drawings, wherein:

FIG. 1 schematically shows a cross-section of a mullion of a window or door equipped with a locking system with an adjustable striker according to the invention;

FIG. 2 shows a perspective view of a section of the profile indicated in FIG. 1 with F2;

FIG. 3 shows the striker indicated in FIG. 2 with F3 on a larger scale;

FIGS. 4 to 6 respectively show views of the accessory according to the invention, respectively according to the arrows F4 to F6 in FIG. 3, whereby in FIG. 6 the accessory is shown in one of its possible mounted positions;

FIGS. 7 to 9 show analogue views such as that of FIG. 6, but always in another mounted mounting position;

FIGS. 10 to 14 show the same views as those of the FIGS. 2 to 6, but for an alternative embodiment of a striker according to the invention and with the striker of FIG. 6 in unmounted condition;

FIG. 15 shows a cross-section according to line XV-XV in FIG. 14;

FIG. 16 shows a view according to FIG. 14, but during the mounting of the striker on a profile of the window or door;

FIG. 17 shows the same figure as FIG. 16, but in a mounted condition;

FIGS. 18 to 20 show a view according to FIG. 16, but in different settings of the striker;

FIG. 21 shows a view as that of FIG. 4, but for another alternative embodiment of a striker according to the invention;

FIGS. 22 and 23 show a view, according to the arrows F22 and F23 respectively of FIG. 21;

FIGS. 24 to 27 show the striker of FIGS. 21 to 23 in different settings;

FIG. 28 shows another variant of a striker according to the invention;

FIGS. 29 and 30 show yet another variant;

FIG. 31 shows a cross-section according to line XXXI-XXXI in FIG. 29;

FIG. 32 shows a variant of FIG. 31;

FIG. 33 shows another variant according to FIG. 29.

### DESCRIPTION OF THE PREFERRED EMBODIMENTS

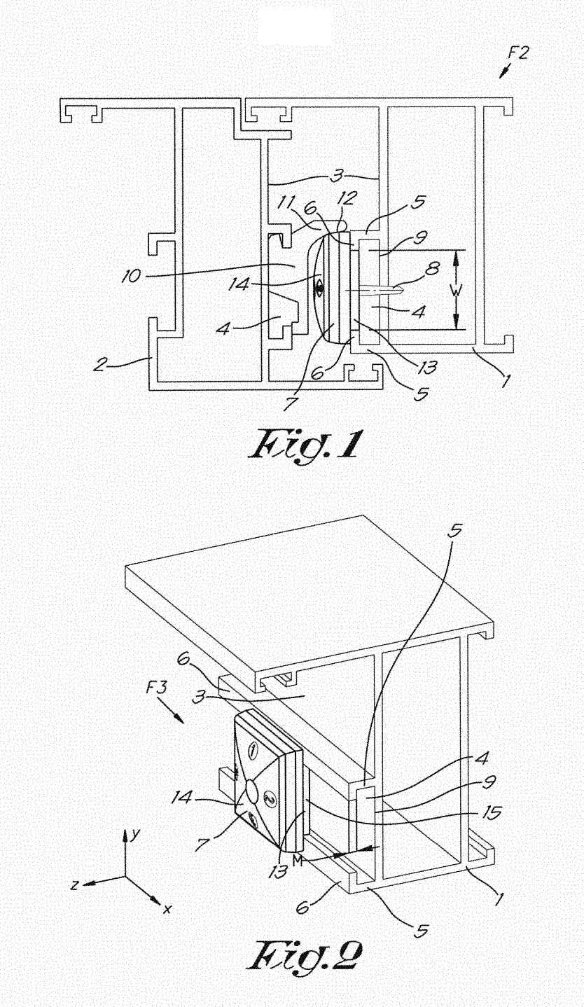

FIG. 1 shows the mullion of a window in a closed condition, in particular a profile 1 of the fixed frame of the window and a profile 2 of the hingeable wing. Profiles 1 and 2 are aluminium profiles for example.

On the sides facing each other 3 the profiles 1 and 2 are provided with a fitting groove 4 which extends lengthways along x and which is defined by two upstanding ribs 5 with jaws oriented toward each other in a perpendicular way which form the flanks 6 of the fitting groove 4 and which limit the width W of this fitting groove 4.

In the fitting groove 4 of the profile 1 of the fixed frame a striker 7 according to the invention is mounted by means of a screw 8 which is screwed in the bottom 9 of the groove 4.

In the fitting groove 4 of the profile 2 of the wing a close slat 10 is provided which has been mounted slidably in the fitting groove 4 and in a known way can be slid in the fitting groove 4 by means of a handle or another control to open or shut the window.

The close slat 10 bears a locking cam 11 which in this case is hook-shaped and which by means of said handle can be hooked behind the striker 7 as shown in FIG. 1 or can be withdrawn to open the window.

An alternative locking system is known whereby the close slat 10 is blocked in the fitting groove in a setting whereby the locking cam 11 holds a fixed position between the hinges of the window opposite the striker 7, such that the locking cam 11 hooks behind the striker 7 by the turning movement of the wing when closing the window or door.

Both locking methods are possible, either with the handle or the turning movement of the wing.

In each of both these methods the locking cam 11 must press firmly against the striker 7 in the lateral direction y′ perpendicular to the longitudinal direction x′ of the fitting groove 4 to ensure proper closing.

For this it is necessary that the position of the contact zone 12 between the locking cam 11 and the striker 7 is adjustable to compensate for the manufacturing and mounting tolerances which ensure that the mutual positions of the opposite fitting grooves 4 of the fixed frame and of the wing can change in the lateral direction y and in the depth direction z by changing their mutual distance.

To this end, the striker according to the invention is adjustable in a way described below.

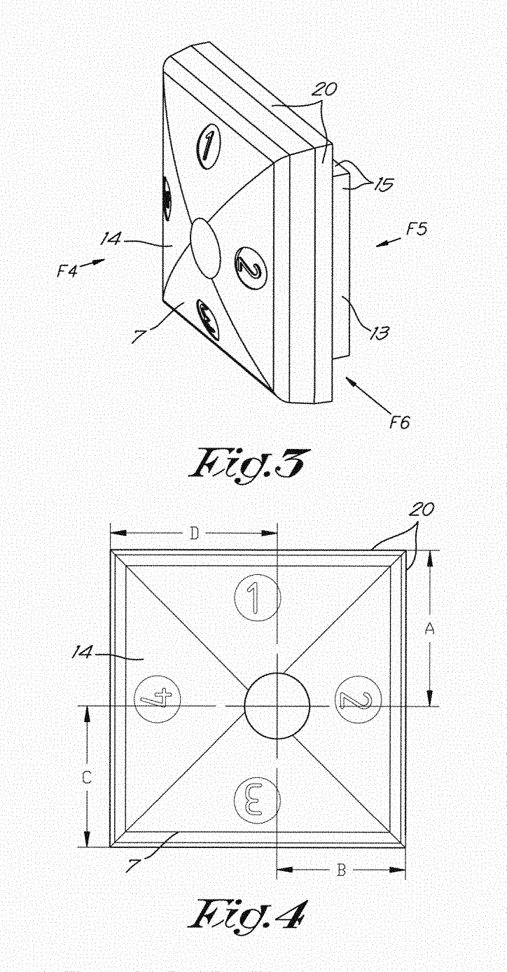

The striker 7 as shown in the FIGS. 3 to 5 is composed of a foot 13 and a head 14 mounted directly along one side thereon.

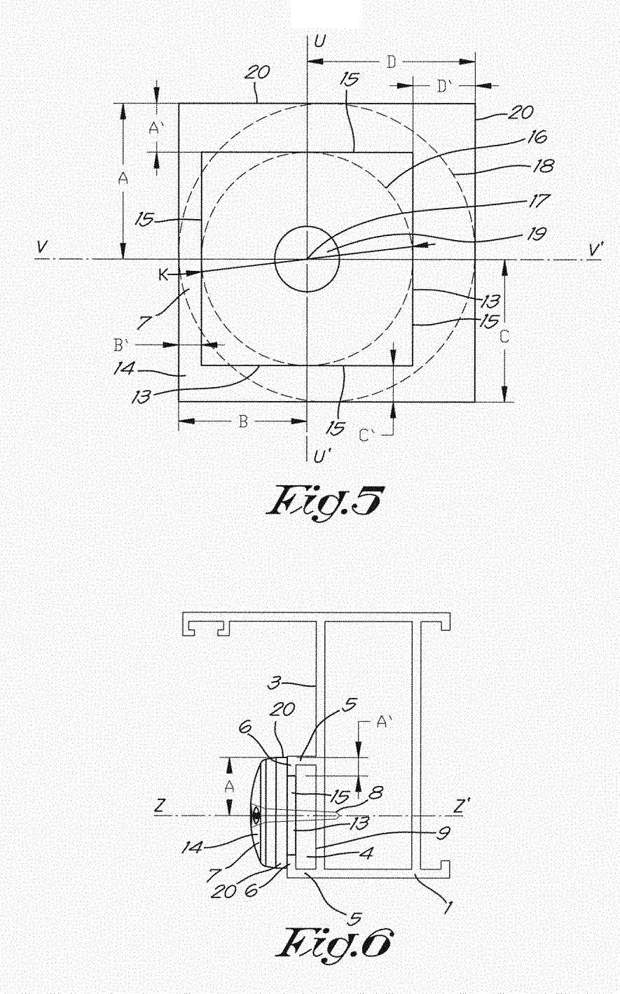

The foot 13 is formed as a disk with edges 15 that define a circumference in the form of a regular polygon with an even number of sides and characterised by an inscribed circle 16, indicated in FIG. 5 with a dashed line, with a centre point 17 and a diameter K, which is equal to or slightly smaller than the width W of the fitting groove 4.

The diameter K of the inscribed circle is also equal to the distance between two facing edges 15 of the foot, whereby the distance in this location determines the width of the foot 13.

In the example shown in FIGS. 1 to 5 the regular polygon is a square with width K.

Such foot thus fits between the flanks 6 of the fitting groove 4 and this in as many different positions as there are edges 15.

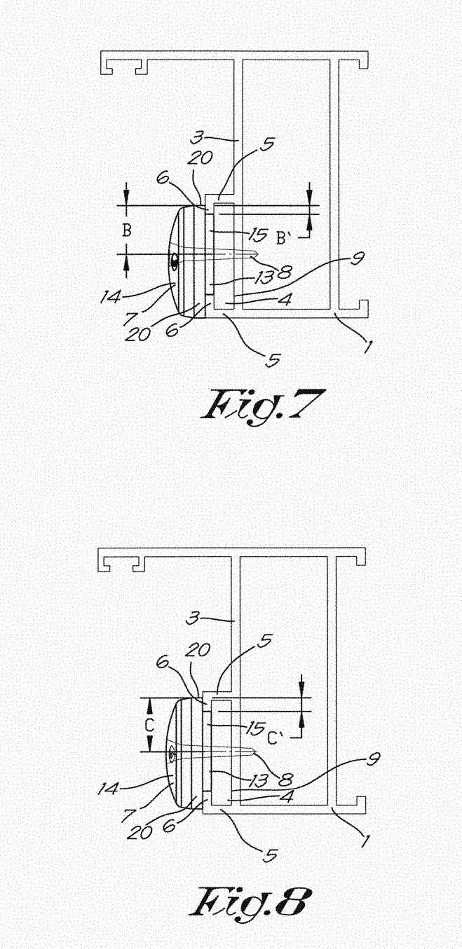

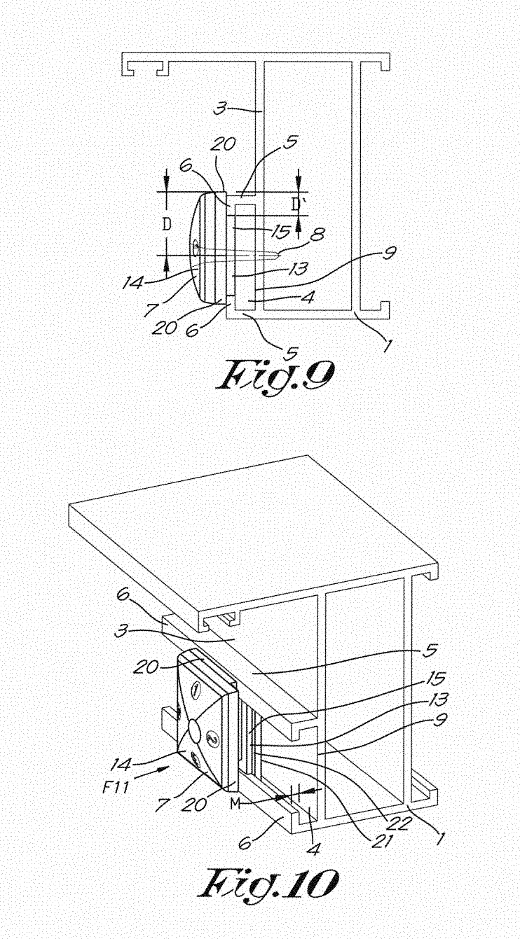

In the shown example with a square foot 13 the striker 7 with its foot 13 can be mounted fittingly in four different positions between the flanks 6 of the fitting groove 4 as shown in FIGS. 6 to 9.

The different positions differ from each other by a rotation of the striker 7 around a geometric axis Z-Z′ through a centre point of the foot 13 that coincides with the centre point 17 of the inscribed circle 16 and which in mounted condition is located in the middle of the fitting groove 4. The centre point 17 can also be determined as the intersection of the geometric centre lines of the groove which can be marked in every position on the foot 13. In FIG. 5 these centre lines are indicated by lines U-U′ and V-V′, whereby the centre lines of each pair of positions coincide with a rotation over a half turn.

In each of these mounted positions the striker 7 is blocked between the flanks 6 of the fitting groove 4 so it cannot rotate.

The geometric axis Z-Z′ in the example coincides with the axis of the screw 8 which, however, does not necessarily have to be the case.

In the extreme, the foot can also be executed as a disk with a circular circumference that coincides with the inscribed circle 16. This means the regular polygon has an infinite number of sides and there are an infinite number of intermediate positions.

The head 14 of the striker 7 has a circumference with straight edges 20 that are determined by the sides of a regular polygon with an inscribed circle 18 with a diameter that is greater than the width W of the fitting groove and the centre point 19 of which is excentrically located in relation to the geometric axis Z-Z′ through the centre point 17 of the foot 13, such that the radial normal distance of the edges 20 to the geometric axis Z-Z′ is different for each edge 20. Straight edges 20 here are understood to mean edges that are rectilinear between two corner points.

In the shown example, centre point 19 in relation to the centre point 17 has shifted according to two orthogonal directions X and Y and over a different distance in every direction.

Preferably, the number of straight edges of the head 14 is equal to the number of straight edges of the foot 13 and the edges 15 and 20 are parallel to each other, such that for every straight edge 15 there is a corresponding edge 20 the orthogonal distance of which to the geometric axis Z-Z′ is different as shown in FIG. 5 in which these distances are indicated with the letters A to D respectively and whereby in this case the distance D is the greatest, followed by the distances A and C to end with the smallest distance B.

Thanks to this difference in distances A to D you also obtain a difference in the distances A′ to D′ between the straight edges 20 of the head 14 and the corresponding straight edges 15 of the foot 13.

The distances A to D determine the position of the edge 20 that is located closest to the locking cam 11 and is parallel with the longitudinal direction x of the fitting groove 4 in relation to the centre of this fitting groove 4.

That means that these distances also determine the lateral position of this edge 20 in relation to the locking cam 11.

In this way a lateral adjustment of the locking system 7-11 is possible by a simple rotation of the mounting position of the striker 7.

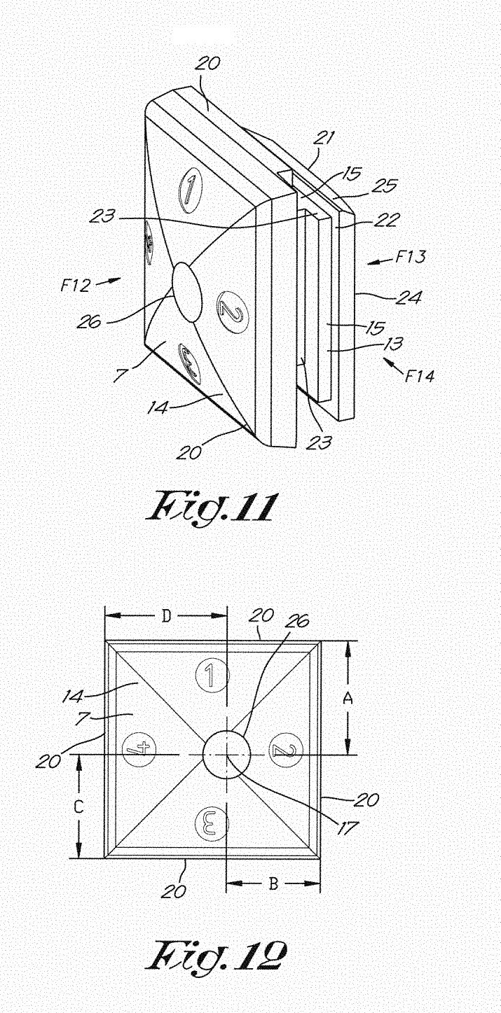

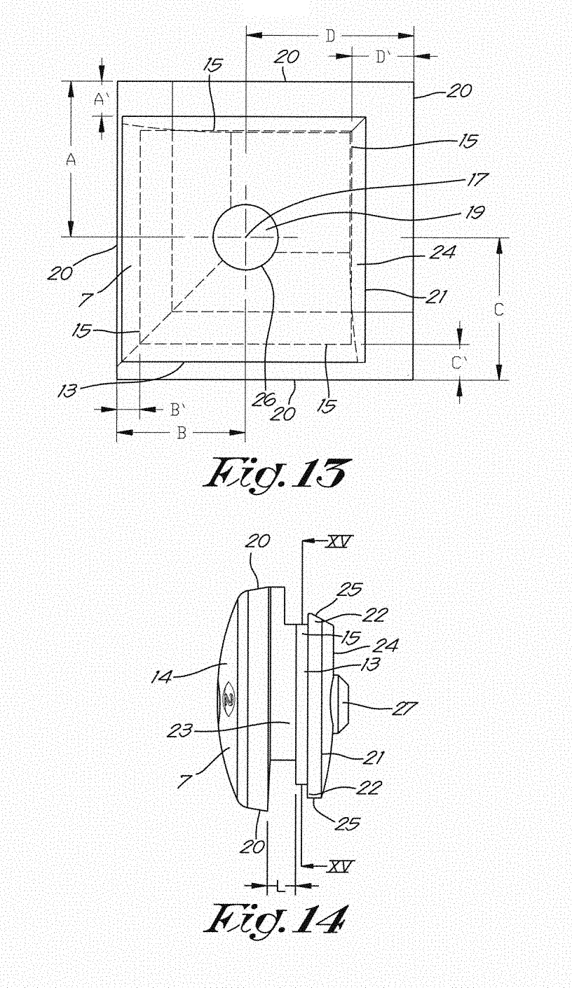

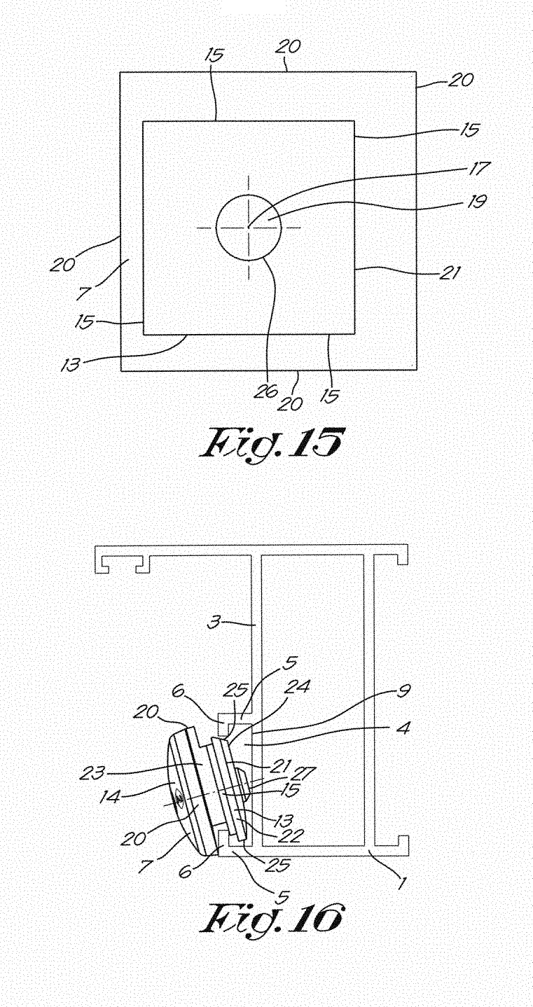

FIGS. 10 to 13 show an alternative embodiment of a striker 7 according to the invention, the difference being that in this case the foot 13, on the opposite side of the head 14, is provided with a clamping piece 21 which along every edge 15 of the foot 13 extends laterally with a collar 22 in relation to the edges 15 of the foot 13.

In this case the head 14 is connected with the foot 13 by means of a connecting piece 23 with a thickness L which is equal to or greater than the thickness M of the flanks 6 of the fitting groove 4 and which at least along two non-facing edges 15 of the foot 13 indents laterally inwardly in relation to these edges 15.

Preferably, this embodiment of a striker 7 is dimensioned such that the striker 7 with the collar 22 of the clamping piece 21 can be hooked behind a flank 6 of the fitting groove 4 and can be tilted into one of said positions in a way as shown in FIG. 16.

It can be useful here that, depending on the depth of the fitting groove 4, the bottom 24 of the clamping piece 21 is bevelled narrowingly toward the edges 25 of the clamping piece 21, whereby the edges 25, or a part thereof, can also be bevelled inwardly.

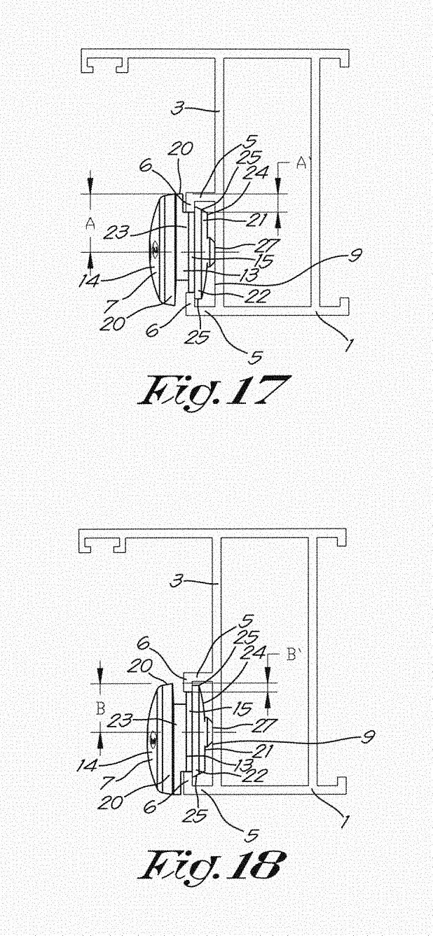

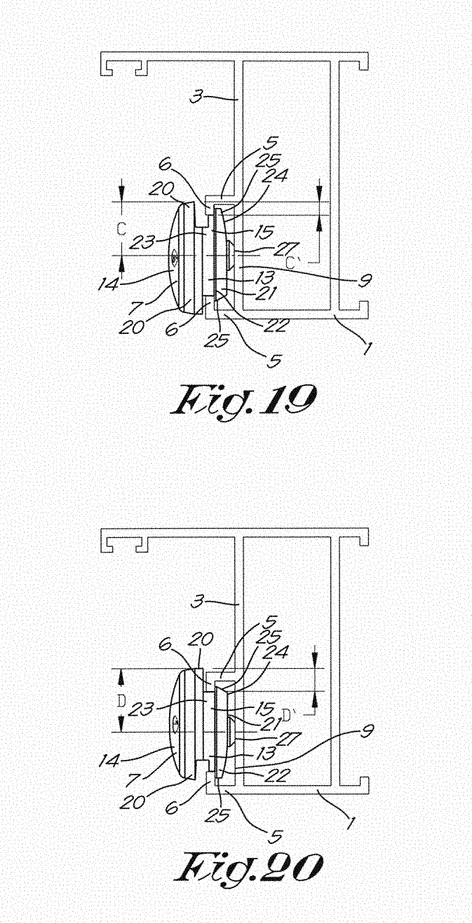

In this embodiment with clamping piece 21 the striker 7 is provided with a screw thread channel 26 with internal thread and a fitting screw 27 which, when it is screwed in the screw thread channel 26, can push against the bottom 9 of the fitting groove 4 to clamp the striker 7 with the collar 22 of the clamping piece 21 tight against the flanks 6 of the fitting groove 4 as shown in the FIGS. 17 to 20 which shows the different settings of the striker 7, and this in the same way as shown in the FIGS. 6 to 9 of the first embodiment.

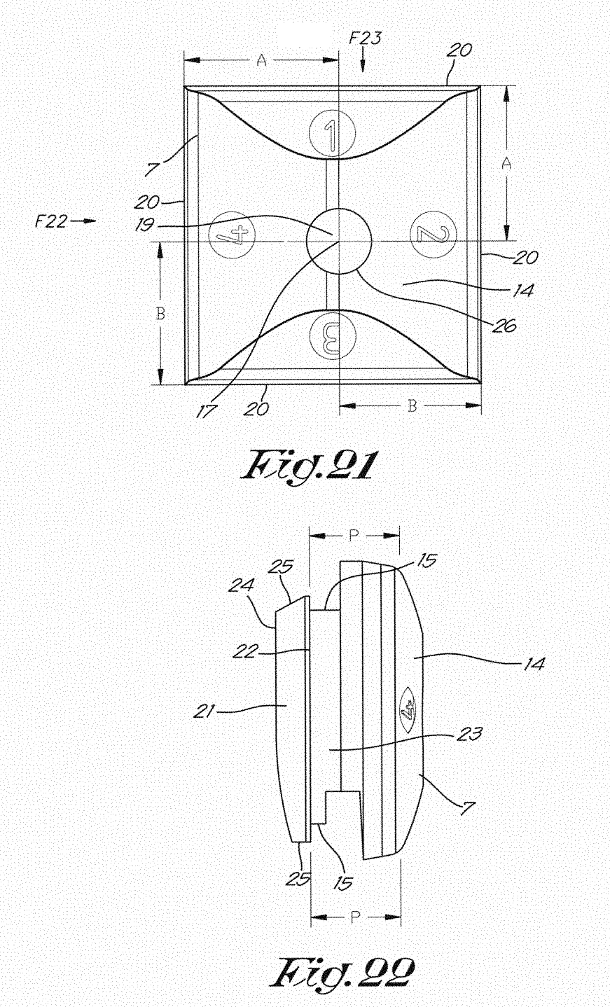

FIGS. 21 to 23 describe a third embodiment of a striker 7 according to the invention whereby in this case the centre point 19 in the two orthogonal directions x and y is shifted over the same distance, such that every time two adjacent edges 20 of the head 14 are located at a same distance A, respectively B, from the centre point 17 of the foot 13.

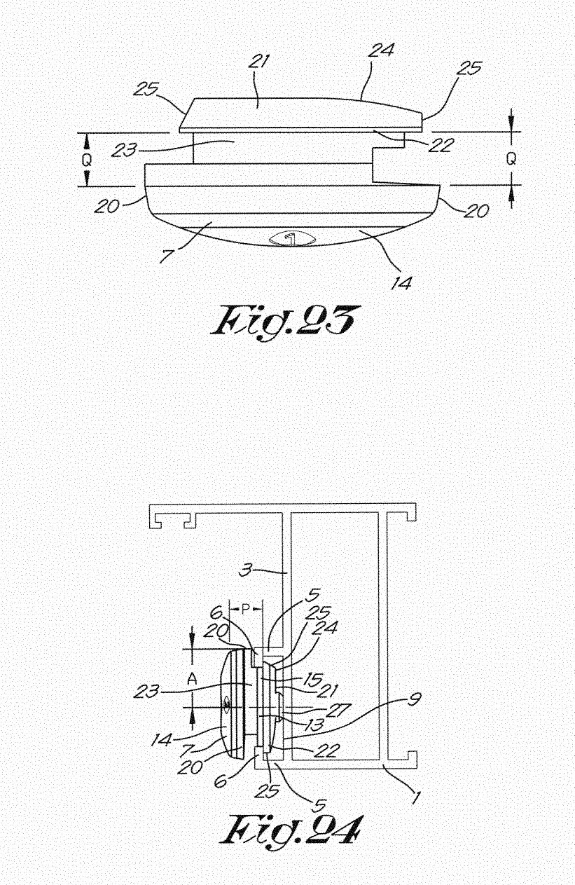

Two facing edges 20 are executed with a same thickness P, whereas the two other facing walls are executed with a different thickness Q as shown in FIGS. 22 and 23, whereby the thickness P and Q are measured according to a direction parallel with the geometric axis Z-Z′ of the striker 7.

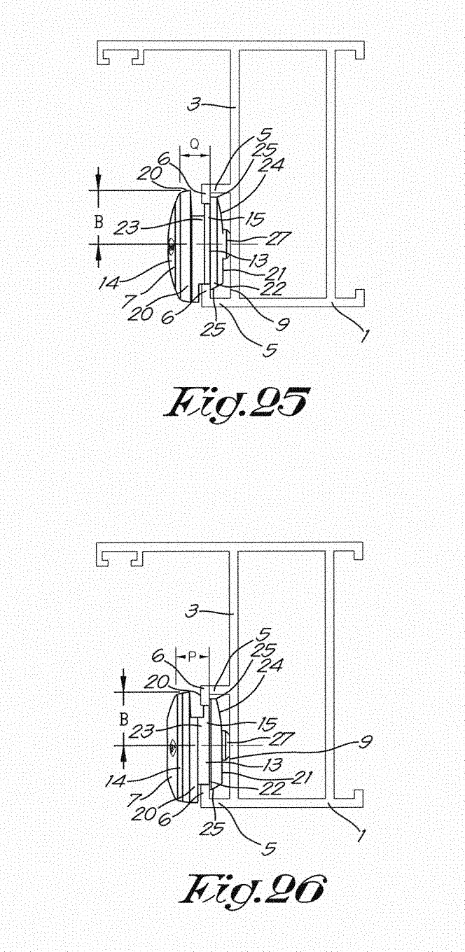

In this case too, the striker 7 has four settings that are shown in FIGS. 24 to 27, whereby in this case both a lateral adjustment and a depth adjustment can be realised.

In the settings of the FIGS. 24 and 26 the edge 20 which is in contact with the locking cam 11 has the same thickness in both cases with a thickness P but by rotating the striker 7 a half turn the lateral distance of this edge 20 to the middle of the fitting groove 4 can be adjusted and because of this the lateral position of this edge 20 in relation to the locking cam 11 too.

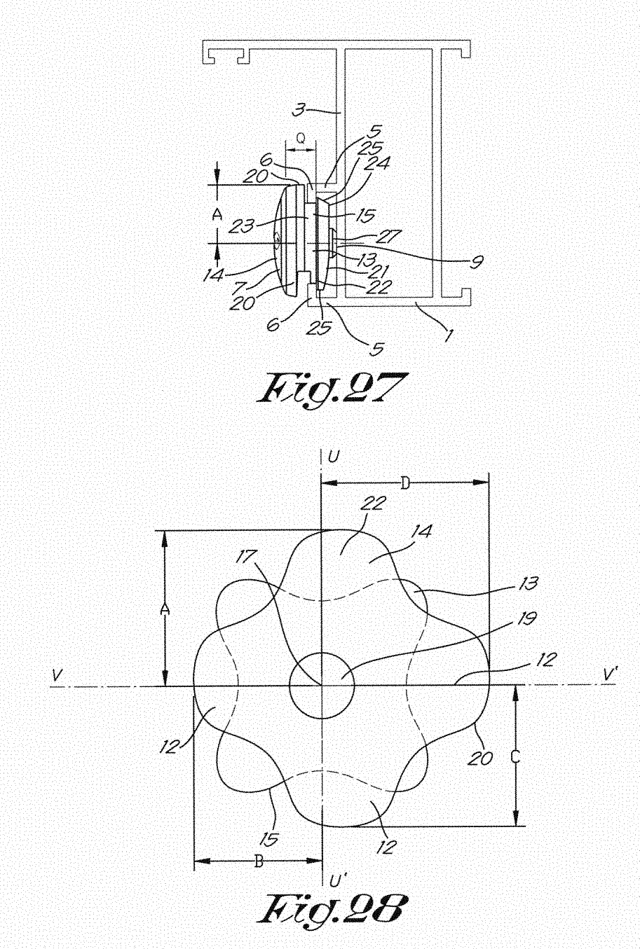

By rotating the striker a quarter turn to the position of FIG. 27, departing from the position of FIG. 24, the lateral adjustment distance A is retained, but the locking cam 11 is now in contact with a thicker edge 20 with thickness Q.

In this way a combined lateral and depth adjustment is possible.

Alternatively, the head 14 is not shifted excentrically in relation to the foot 13 and the four edges 20 show a different thickness.

In this case the adjustment is restricted to a depth adjustment.

It is clear that the foot 13 does not necessarily have to have straight edges, but needs a form that allows the foot to be blocked in different positions in the fitting groove, which positions differ from each other by a mutual rotation of the positions around a geometric axis Z-Z′ through a centre point 17 that is determined as intersection of the middle lines of the fitting groove 4 which can be projected in the different positions on the foot 13. A possible example of this is shown in FIG. 28 in which the foot 13 is star-shaped with a centre point 17 in the intersection of the centre lines U-U′ and V-V′.

It is clear that the edges of the head do not necessarily have to be straight, but that, for example, a circular head 14 can be combined with a polygonal foot 13 or a head 14 with an irregular form the edges 20 of which are located locally along the different centre lines of each pair of parallel edges of the foot 13 at a different distance A,B,C,D of the geometric axis Z-Z′ as in these local places the contact zone 12 with the locking cam 11 is situated. FIG. 28 is an example of this with a star-shaped head that is centred in relation to the centre point 17.

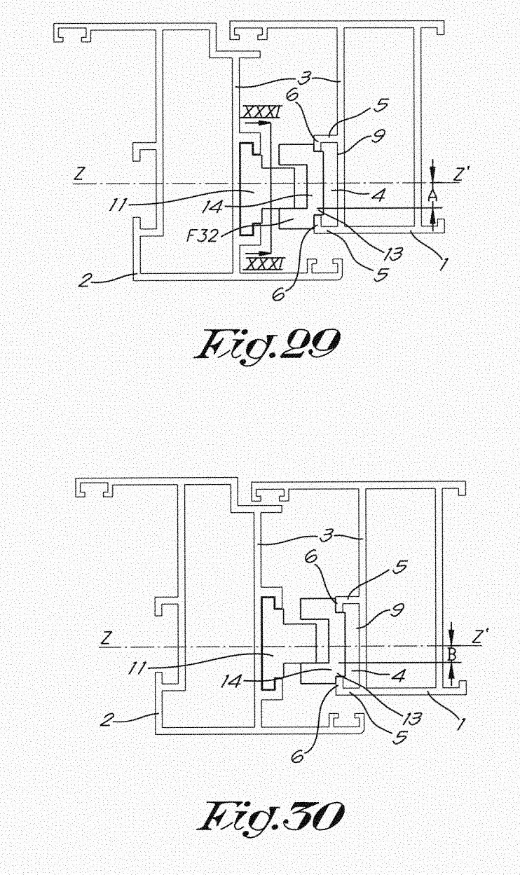

FIGS. 29 and 30 show another variant of a striker 7 according to the invention.

It is also clear that the diameter of the inscribed circle 18 can be smaller than the diameter of the inscribed circle 16. In that case the striker 7 can be mounted in the fitting groove 4 by means of an aforementioned clamping piece 21 or by screwing the striker 7 against the bottom 9 of the fitting groove 4.

A variant embodiment of a striker 7 according to the invention is shown in the FIGS. 29 to 32.

In this case the foot 13 is executed as a rectangular slat which only fits in the fitting groove in two ways, more specifically in two positions that are rotated half a turn in relation to each other around an axis Z-Z′ through a centre point 17 located on centre line U-U′ of the foot 13 corresponding with said two positions.

The head in the example is executed as a U-shaped profile which when locking the window or the door grips over a locking cam 11 in the form of a pen with this locking cam 11 between the legs 28.

In this case the contact zones 12 with the locking cam 11 are located on the edges 29 of the legs facing each other 28 of the striker 7.

The head 14 is connected with the foot such that the lengthways edges 29 are parallel with the centre line U-U′ of the foot 13, whereby the U-shaped end piece has excentrically shifted in relation to the centre line U-U′ in a direction perpendicular to the centre line U-U′ or at least such that the edges 29 and therefore also the contact zones 12 are located at a different distance A, respectively B, from the centre line U-U′.

In this way a simple lateral adjustment is obtained in two settings by mounting the striker 7 in the one or in the other of the two possible positions in the fitting groove 4 as illustrated with the FIGS. 29 and 30 which each show one of the two settings.

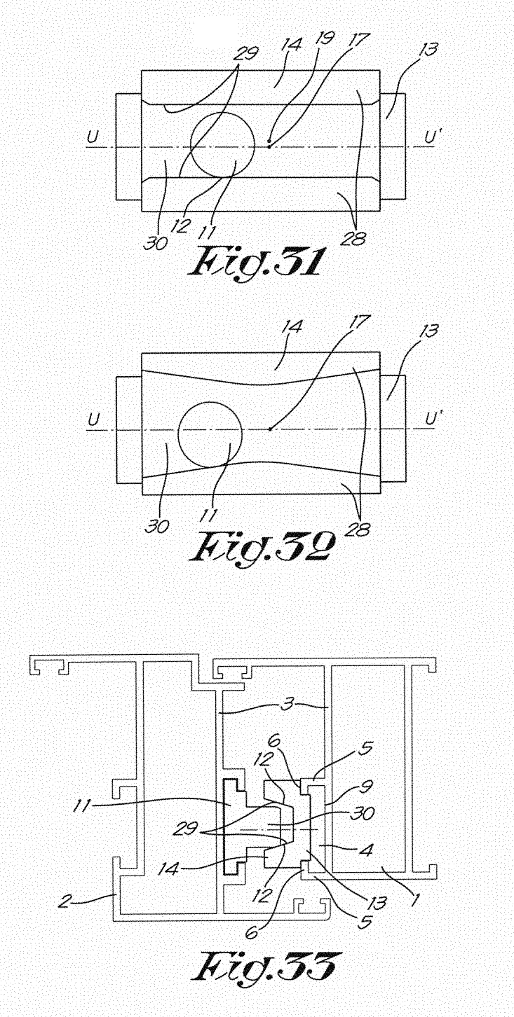

In the variant embodiment of FIG. 31, the thickness of the legs 28 is additionally executed varyingly in the profile directions of the legs such that the distance of the edges 29 of the legs 28 also varies in this direction such that the width of the groove 30 between the legs 28 from each end of the U-shaped head 14 gets smaller toward the middle and this groove 30 thus narrows toward the middle.

This makes an additional lateral adjustment possible by shifting the striker in the one or in the other position in a longitudinal direction x of the fitting groove 4.

FIG. 32 shows another optional additional depth adjustment by executing the edges 29 of the legs 28 with a slope such that the width of the groove 30 becomes smaller from the opening of the groove 30 to the bottom of this groove 30 and the thickness of the edges 29 is, in other words, variable in the direction Z-Z′.

This makes a depth adjustment possible by shifting the striker 7 lengthways along x of the fitting groove 4.

The present invention is by no means limited to the embodiments described as an example and shown in the drawings, but a striker according to the invention for a door or window that can be realised in all kinds of forms and dimensions, without departing from the scope of the invention.

1. Striker for a window or door with at least one profile (1) with a fitting groove (4) which breadthways is limited by two parallel flanks(6) and provided with a locking system with a striker and a co-operating locking cam (11) to lock the window or door in the closed condition, which striker (7) is intended to be mounted on the level of an aforementioned fitting groove (4) and when locking to be able to make contact with a contact zone (12) by means of the locking cam (11), wherein the striker (7) is composed of a foot (13) and a head mounted sideways thereon (14), whereby the foot (13) in a mounted condition of the striker (7) fits in several different positions between the flanks (6) of the fitting groove (4), whereby every position corresponds with a geometric centre line (U-U′,V-V′) of the foot (13) which coincides with the middle line between the flanks (6) of the fitting groove (4) and the different positions differ from each other by a rotation of the striker (7) around a geometric axis (Z-Z′) through a centre point (17) which is located on an aforementioned centre line or in the intersection of several centre lines (U-U′,V-V′) of the foot (13), and whereby the head (14) possesses at least two different said contact zones (12) the distance (A,B,C,D) of which to the geometric axis (Z-Z′) through the centre point (17) of the foot (13) is different and/or the thickness (P,Q) is different.

2. Striker according to claim 1, wherein for each pair of said positions of the foot (7) in which the foot (13) fits between the flanks (6) of the fitting groove (4) and which differ from each other by a rotation of the striker (7) over a half turn around the geometric axis (Z-Z′), two contact zones (12) are provided which in relation to this geometric axis (Z-Z′) are located diametrically opposite each other and at a different radial distance (A,B,C,D) therefrom and/or with a different thickness (P,Q).

3. Striker according to claim 1, wherein that the foot (13) is a disk with edges (15) along its circumference in the form of a regular polygon with an even number of sides and having an inscribed circle (16) with a centre point (17) that coincides with said centre point (17) of the foot (13) and a diameter which is equal to or slightly smaller than the width (W) of the fitting groove (4).

4. Striker according to claim 3, wherein the foot (13) is a disk with a circular circumference and an infinite number of sides as it were and with a diameter which is equal to or slightly smaller than the width (W) of the fitting groove (4).

5. Striker according to claim 3, wherein the circumference of the head (14) is formed by a regular polygon with an inscribed circle (18), the centre point (19) of which is eccentrically located in relation to the centre point (17) of the foot (13) according to two orthogonal directions (x,y) at least one of which is perpendicular to the edge (15) of the foot (13), whereby the contact zones (12) are located along the circumference.

6. Striker according to claim 5, wherein the contact zones (12) are situated along the circumference of the head (14) on the level of the contact points of the edges with the inscribed circle (18).

7. Striker according to claim 5, wherein the edges (20) along the circumference of the head (14) run parallel with the edges (15) along the circumference of the foot (13).

8. Striker according to claim 5, wherein the diameter of the inscribed circle (18) of the circumference of the head (14) is greater than the diameter of the inscribed circle (16) of the foot (13).

9. Striker according to claim 1, wherein the striker (7) is provided with a channel for a screw and a fitting screw (8) with which the striker (7) in one of said positions can be blocked by screwing the screw in the bottom (9) of the fitting groove (4).

10. Striker according to claim 1, wherein the thickness (P,Q) of the edges (20) along the circumference of the head (14) is not constant, whereby the thickness is considered in a direction parallel with said geometric axis (Z-Z′) of the foot (13).

11. Striker according to claim 10, wherein at least two non-facing edges (20) of the head (13) show a different thickness (P,Q).

12. Striker according to claim 1, wherein the head (14) is mounted directly on the foot (13).

13. Striker according to claim 1, character wherein the foot (13) on the opposite side of the head (14) is provided with a clamping piece (21) which along every edge (15) of the foot (13) extends laterally with a collar (22) in relation to the foot (13).

14. Striker according to claim 13, cha wherein the head (14) is connected with the foot (13) by means of a connecting piece (23) with a thickness (L) which is equal to or greater than the thickness (M) of the flanks (6) of the fitting groove (4) and which at least along two non-facing edges (15) of the foot (13) indents laterally inwardly in relation to these edges (15).

15. Striker according to claim 14, wherein the striker is dimensioned such that it can be hooked with a collar (22) of the clamping piece (21) behind a flank (6) of the fitting groove (4) and can be tilted in to one of said positions.

16. Striker according to claim 14, wherein the bottom (23) of the clamping piece (21) is bevelled narrowingly toward the edges (24) of the clamping piece (21).

17. Striker according to claim 13, further comprising a screw channel (26) and a fitting screw (27) which, when it is screwed in the screw thread channel (26), can push against the bottom (9) of the fitting groove (4) to clamp the striker (7) with the collar (22) of the clamping piece (21) tight against the flanks (6) of the e fitting groove.

18. Striker according to claim 1, wherein the striker (7) is formed by a head (14) in the form of a U-shaped profile with two legs (28) with contact zones (12) on facing edges (29) of the legs (28) and with at least two positions rotated over a half turn in relation to each other between the flanks (6) of the fitting groove (4) in which the edges facing each other (29) run parallel with the centre line (U-U′) of the foot (13) corresponding with these two different positions of the foot (13) and each at a different distance (A,B) of this centre line (U-U′).

19. Striker according to claim 2, wherein the foot (13) is a disk with edges (15) along its circumference in the form of a regular polygon with an even number of sides and having an inscribed circle (16) with a centre point (17) that coincides with said centre point (17) of the foot (13) and a diameter which is equal to or slightly smaller than the width (W) of the fitting groove (4).

20. Striker according to claim 4, wherein the circumference of the head (14) is formed by a regular polygon with an inscribed circle (18), the centre point (19) of which is eccentrically located in relation to the centre point (17) of the foot (13) according to two orthogonal directions (x,y) at least one of which is perpendicular to the edge (15) of the foot (13), whereby the contact zones (12) are located along the circumference.
